(19) United States
(12) Patent Application Publication
(10) Pub. No.: US 2016/0364266 A1
(43) Pub. Date: Dec. 15, 2016

(54) RELATIONSHIP MANAGEMENT OF APPLICATION ELEMENTS

(71) Applicant: International Business Machines Corporation, Armonk, NY (US)

(72) Inventors: Paul R. Bastide, Boxford, MA (US); Matthew E. Broomhall, Goffstown, NH (US); Robert E. Loredo, North Miami Beach, FL (US); Fang Lu, Billerica, MA (US)

(21) Appl. No.: 14/737,525

(22) Filed: Jun. 12, 2015

(51) Int. Cl. G06F 9/48; G06F 3/0484

(52) U.S. Cl. CPC G06F 9/4881; G06F 3/0484

(57) ABSTRACT

A method for artifact management is provided. A first artifact in a user interface is detected, wherein the first artifact is in use. One or more related artifacts are determined, wherein the related artifacts are operating in the user interface. The related artifacts have a degree of relatedness to the first artifact. An affinity factor is generated for each of the related artifacts. The competition of a task associated with the first artifact is detected. A second artifact is retrieved, wherein the second artifact is from the related artifacts.

### BACKGROUND OF THE INVENTION

The present invention relates generally to the field of attention management, and more particularly to managing user context changes.

Computer applications are used for an immeasurable number of tasks. Often, users use multiple computer applications simultaneously. For example, at any one time, a user may have work email, a calendar meeting, a personal email, a database, and any number of other applications open at one time. Each of the computer applications contains one or more artifacts, or an element within the application that requires the user's attention.

Each application and artifact utilizes computer resources. Additionally, switching between each of the artifacts utilizes user time. For example, the user has to identify the context of each artifact each time the artifact is opened. The task of identifying artifact context can take several seconds per artifact. Further, user time is utilized deciding in what order to complete a set of tasks.

### SUMMARY

According to one embodiment of the present disclosure, a method for artifact management is provided. The method includes detecting, by one or more processors, a first artifact in a user interface, wherein the first artifact is in use; determining, by one or more processors, one or more related artifacts, wherein the one or more related artifacts are operating in the user interface, and wherein the one or more related artifacts have a degree of relatedness to the first artifact; generating, by one or more processors, an affinity factor for each of the one or more related artifacts; detecting, by one or more processors, completion of a task associated with the first artifact; and retrieving, by one or more processors, a second artifact, wherein the second artifact is from the one or more related artifacts.

According to another embodiment of the present disclosure, a computer program product for artifact management is provided. The computer program product comprises a computer readable storage medium and program instructions stored on the computer readable storage medium. The program instructions include program instructions to detect a first artifact in a user interface, wherein the first artifact is in use; program instructions to determine one or more related artifacts, wherein the one or more related artifacts are operating in the user interface, and wherein the one or more related artifacts have a degree of relatedness to the first artifact; program instructions to generate an affinity factor for each of the one or more related artifacts; program instructions to detect completion of a task associated with the first artifact; and program instructions to retrieve a second artifact, wherein the second artifact is from the one or more related artifacts.

According to another embodiment of the present disclosure, a computer system for artifact management is provided. The computer system includes one or more computer processors, one or more computer readable storage media, and program instructions stored on the computer readable storage media for execution by at least one of the one or more processors. The program instructions include program instructions to detect a first artifact in a user interface, wherein the first artifact is in use; program instructions to determine one or more related artifacts, wherein the one or more related artifacts are operating in the user interface, and wherein the one or more related artifacts have a degree of relatedness to the first artifact; program instructions to generate an affinity factor for each of the one or more related artifacts; program instructions to detect completion of a task associated with the first artifact; and program instructions to retrieve a second artifact, wherein the second artifact is from the one or more related artifacts.

### BRIEF DESCRIPTION OF THE DRAWINGS

FIG. 1 is a functional block diagram illustrating a computing environment, in accordance with an embodiment of the present disclosure;

FIG. 2 is a flowchart depicting operations for managing artifacts, on a computing device within the computing environment of FIG. 1, in accordance with an embodiment of the present disclosure; and

FIG. 3 is a block diagram of components of a computing device executing operations for managing application elements, in accordance with an embodiment of the present disclosure.

### DETAILED DESCRIPTION

An embodiment of the present invention recognizes that multiple applications in the user interface (UI) of a computing device compete for user attention and cause performance issues (e.g., thrashing). Further, user time is spent determining what tasks to complete, switching between artifacts in applications, and determining the context of each artifact. While it may only take a user several seconds to determine the context of an artifact, throughout the day a significant amount of time can be spent establishing context with each artifact or application.

An embodiment of the present invention provides operations to manage relationships between applications and artifacts within each application. An embodiment of the present invention monitors user actions to learn user workflow practices. The workflow practices are used in addition to a degree of relatedness score to queue and retrieve application artifacts. In some embodiments, in response to a user finishing a task within a first application artifact, the present invention retrieves and displays a new application artifact. The new artifact is calculated to be the best artifact for workflow. The retrieval operations allow a user to efficiently use time. For example, the user does not have to switch between and determine the context for multiple artifacts in order to find the user's next task.

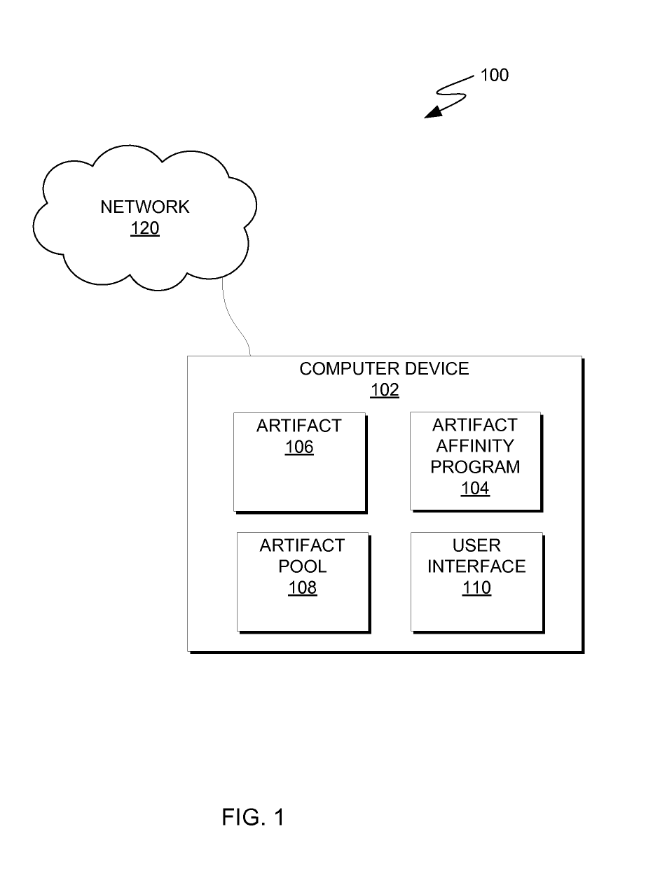

The present disclosure will now be described in detail with reference to the Figures. FIG. 1 is a functional block diagram illustrating a computing environment, in accordance with an embodiment of the present disclosure. For example, FIG. 1 is a functional block diagram illustrating computing environment 100. Computing environment 100 includes computing device 102 connected to network 120. Computing device 102 includes artifact affinity program 104, artifact 106, artifact pool 108, and user interface 110.

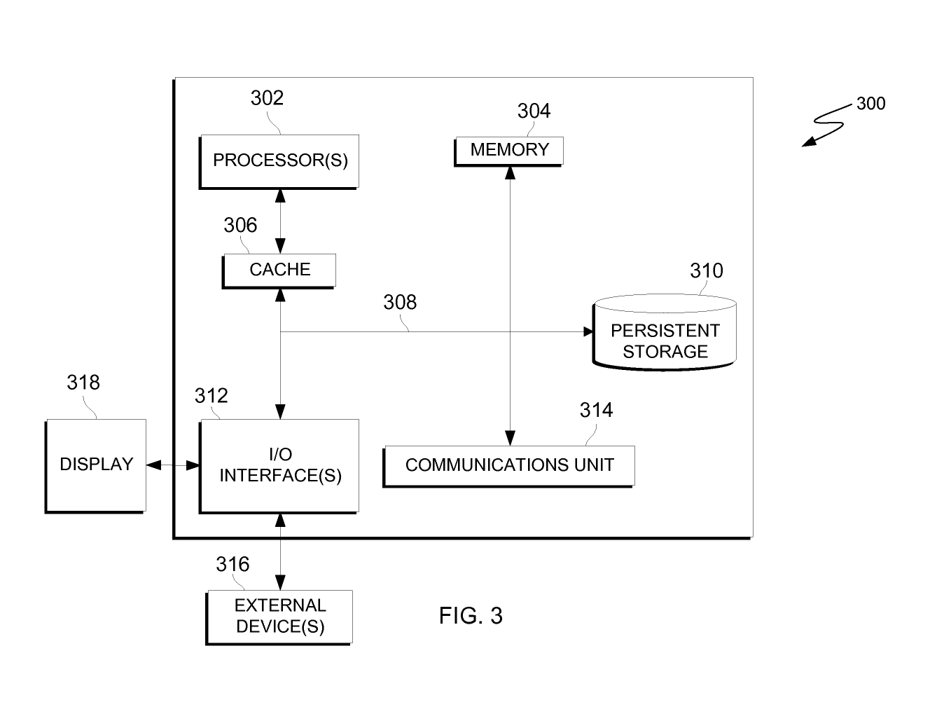

In various embodiments, computing device 102 is a computing device that can be a standalone device, a server, a laptop computer, a tablet computer, a netbook computer, a personal computer (PC), or a desktop computer. In another embodiment, computing device 102 represents a computing system utilizing clustered computers and components to act as a single pool of seamless resources. In general, computing device 102 can be any computing device or a combination of devices with access to and/or capable of executing some or all of artifact affinity program 104, artifact 106, and artifact pool 108. Computing device 102 may include internal and external hardware components, as depicted and described in further detail with respect to FIG. 3.

In this exemplary embodiment, artifact affinity program 104, artifact 106, and artifact pool 108 are stored on computing device 102. In other embodiments, some or all of artifact affinity program 104, artifact 106, and artifact pool 108 may reside on another computing device, provided that each can access and is accessible by each other of artifact affinity program 104, artifact 106, artifact pool 108, and user interface 110. In yet other embodiments, some or all of artifact affinity program 104, artifact 106, and artifact pool 108 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 102 and other devices, in accordance with a desired embodiment of the present invention.

Artifact affinity program 104 operates to monitor user actions, score artifacts in artifact pool 108, queue artifacts based on user needs, and retrieve artifacts from artifact pool 108. Artifact affinity program 104 includes a self-learning algorithm. Artifact affinity program 104 monitors user actions such as which artifacts a user uses, how frequently an artifact is used, the duration of artifact use, actions taken with an artifact, pattern of artifact use (e.g., whether certain artifacts are used in the same order), a specific time of artifact use, etc. Data collected from artifact affinity program 104 monitoring a user's actions on computing device 102 is used by the self-learning algorithm. As data is collected by artifact affinity program 104, the self-learning algorithm processes the data to establish user action patterns. The patterns are used by the artifact affinity program 104 to score artifacts in artifact pool 108. The artifacts of artifact pool 108 are scored based on their degree of relatedness to artifact 106. After scoring each of the artifacts in artifact pool 108, artifact affinity program 104 queues an artifact of artifact pool 108. In response to determining that a user has terminated use of artifact 106, artifact affinity program 104 retrieves and displays the queued artifact.

The monitoring, self-learning, queuing, and retrieval of artifacts may minimize the time spent by the user in switching between artifacts on computing device 102. For example, where an artifact in artifact pool 108 is queued and retrieved based on user patterns learned by the algorithm, the user does not have to search through artifact pool 108 to find the needed artifact. Searching, opening, and putting context to each artifact in artifact pool 108 is a time consuming activity for a user. Artifact affinity program 104 allows for an efficient workflow for the user.

Artifact 106 is an element of a software application that requires a user's attention to complete an action, operating on computing device 102. In some embodiments, artifact 106 is a software application that allows a user to complete a task. For example, artifact 106 can be an email client. In other embodiments, artifact 106 is a portion of a software application that allows a user to execute a task. For example, artifact 106 can be a calendar meeting in personal information manager (PIM) software. Examples of artifact 106 include, but are not limited to, emails, messages calendar meetings, tasks, messaging systems, alerts, websites, etc. Artifact 106 is the artifact in use by a user of computing device 102.

Artifact pool 108 is one or more artifacts operating in the background of computing device 102. In some embodiments, multiple artifacts operate simultaneously on computing device 102. Each artifact in artifact pool 108 can be a software application or a portion of a software application. In some embodiments, an artifact in artifact pool 108 and artifact 106 are each a portion of the same software application. For example, artifact 106 can be an email in a PIM software and an artifact in artifact pool 108 can be a calendar meeting in the PIM software. Each artifact in artifact pool 108 is scored by artifact affinity program 104. The score is based on the degree of relatedness of the artifact of artifact pool 108 to artifact 106.

Computing device 102 includes user interface (UI) 110, which executes locally on computing device 102 and operates to provide a UI to a user of computing device 102. User interface 110 further operates to receive user input from a user via the provided user interface, thereby enabling the user to interact with computing device 102. In some embodiments, user interface 110 includes a graphical user interface (GUI), on which a user can view elements of artifact affinity program 104, artifact 106, and artifact pool 108. In one embodiment, user interface 110 provides a user interface that enables a user of computing device 102 to interact with artifact affinity program 104 of computing device 102. In various examples, the user interacts with artifact affinity program 104 in order to configure queuing results for artifact pool 108. In one embodiment, user interface 110 is stored on computing device 102. In other embodiments, user interface 110 is stored on another computing device, provided that user interface 110 can access and is accessible by at least artifact affinity program 104.

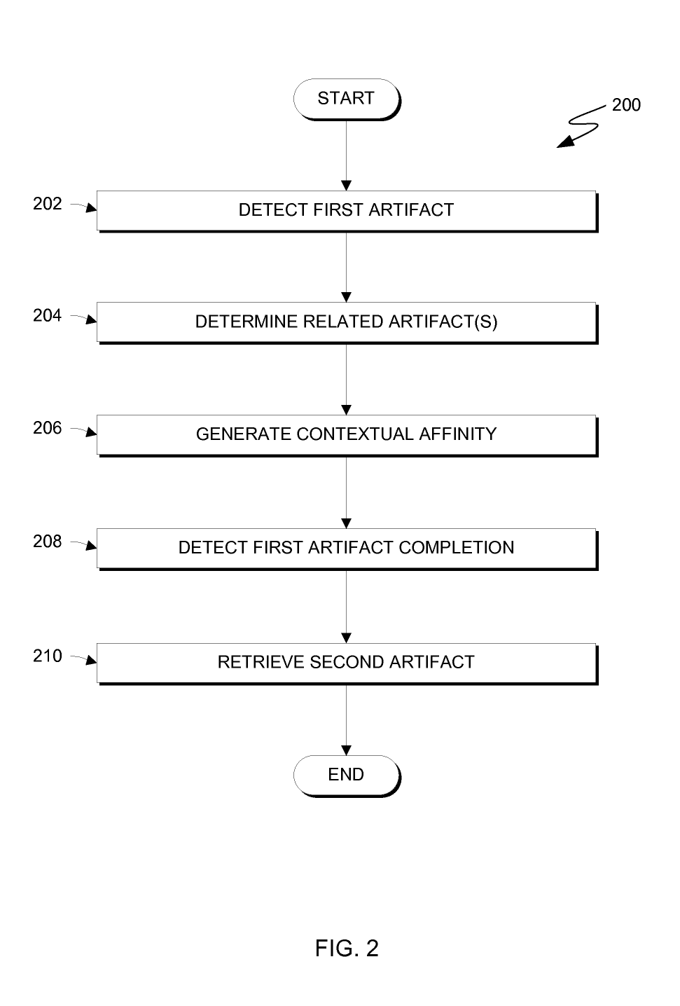

FIG. 2 is a flowchart depicting operations for managing artifacts, on a computing device within the computing environment of FIG. 1, in accordance with an embodiment of the present disclosure. For example, FIG. 2 is a flowchart depicting operations 200 of artifact affinity program 104, on computing device 102 within computing environment 100.

In step 202, artifact affinity program 104 detects a first artifact. Artifact affinity program 104 monitors a user's actions on computing device 102. Based on the monitoring, artifact affinity program 104 detects user activity within the first artifact. For example, the first artifact can be artifact 106 of FIG. 1. In some embodiments, user activity is an interaction with the first artifact via user interface 110. For example, a user typing an email within artifact is user activity used by artifact affinity program 104 to detect the first artifact.

In step 204, artifact affinity program 104 determines one or more artifacts related to the first artifact. Artifact affinity program 104 monitors other artifacts operating in the background of computing device 102. For example, the other artifacts can be part of artifact pool 108 of FIG. 1. Based on the monitoring of artifact pool 108, artifact affinity program 104 determines whether the artifacts are related to the first artifact. Related artifacts can include some or all of artifact pool 108. In some embodiments, an artifact is determined to be related based on past user patterns. In some embodiments, the number of artifacts determined to be related is static. For example, artifact affinity program 104 determines that a set number of artifacts are related to the first artifact. In other embodiments, the number of artifacts determined to be related is dynamic. For example, after artifact affinity program 104 determines that a number of artifacts are related to the first artifact, the user receives a new email. Artifact affinity program 104 determines that the email is related; therefore, the number of related artifacts changes.

Artifact affinity program 104 monitors multiple features of an artifact to determine the context of the artifact. The context is used to determine a degree of relatedness of an artifact of artifact pool 108 (FIG. 1) to the first artifact. For example, artifact affinity program 104 looks to the subject or title of the artifact; users, authors, and readers of the artifact; and natural language characteristics and syntax of the artifact (e.g., computational linguistics, parts-of-speech, and N-Grams).

In step 206, artifact affinity program 104 generates a contextual affinity. The contextual affinity is based on user history and is measured as a degree of relatedness between the first artifact and another artifact. For example, artifact affinity program 104 monitors a user's action on computing device 102 to determine usage patterns. Artifact affinity program 104 looks to user usage patterns, such as how often an artifact is used, a recurring order of artifact usage, time and duration of use, etc. In some embodiments, artifact affinity program 104 uses context from within the first artifact to generate the contextual affinity. For example, the user receives an email from a colleague discussing a potential date for a meeting. Artifact affinity program 104 uses the date to determine that a calendaring artifact is related.

In some embodiments, the contextual affinity is a numerical score. For example, the contextual affinity can be a percentage, such that a close contextual match results in a high percentage. In other embodiments, the contextual affinity is a ranking. For example, artifact affinity program 104 compares each artifact in artifact pool 108 to the other artifacts to determine a ranking. In this embodiment, the related artifact that most closely matches the contextual affinity of the first artifact has a rank of 1.

In some embodiments, each of the context features of the artifact are given weights to determine the contextual affinity. In some embodiments, the weights are pre-set within artifact affinity program 104. In other embodiments, users and administrators are able to apply custom weights to specific features. For example, an administrator can assign a higher weighting to the subject of the artifact than the readers of the artifact. In this example, the context of the artifacts' subject will be weighed more heavily than the context of the artifacts' readers. User and administrators modify the weights of features through interaction with the user interface. In yet other embodiments, the weights are changed by artifact affinity program 104 based on the self-learning algorithm and user feedback. For example, where a user switches from an artifact retrieved by artifact affinity program 104 (step 210) without performing a task within the artifact, artifact affinity program 104 may update the weightings of artifact features to provide the user with improved results.

In step 208, artifact affinity program 104 detects the completion of a task within the first artifact. Completion of the artifact task can be detected through a number of user actions. For example, the user can close the artifact, send the artifact (e.g., email), delete the artifact (e.g., a calendar invite), check a box indicating that an action is complete, or dismiss the artifact (e.g., an alert). Each user action signifies that the user has completed the task within the artifact.

In step 210, artifact affinity program 104 retrieves a second artifact. In response to completing tasks associated with the first artifact, artifact affinity program 104 retrieves the related artifact with the highest contextual affinity. For example, in response to the user sending an email about an event date, artifact affinity program 104 retrieves and displays a calendaring artifact. In some embodiments, artifact affinity program 104 retrieves multiple artifacts and presents a prompt to the user to select the next artifact. In this embodiment, artifact affinity program 104 may include a caption with each option to provide context to the user.

FIG. 3 is a block diagram of components of a computing device, generally designated 300, in accordance with an embodiment of the present disclosure. In one embodiment, computing device 300 is representative of computing device 102. For example, FIG. 3 is a block diagram of computing device 102 within computing environment 100 executing operations of artifact affinity program 104.

It should be appreciated that FIG. 3 provides only an illustration of one implementation and does not imply any limitations with regard to the environments in which different embodiments may be implemented. Many modifications to the depicted environment may be made.

Computing device 300 includes communications fabric 308, which provides communications between computer processor(s) 302, memory 304, cache 306, persistent storage 310, communications unit 314, and input/output (I/O) interface(s) 312. Communications fabric 308 can be implemented with any architecture designed for passing data and/or control information between processors (such as microprocessors, communications and network processors, etc.), system memory, peripheral devices, and any other hardware components within a system. For example, communications fabric 308 can be implemented with one or more buses.

Memory 304 and persistent storage 310 are computer-readable storage media. In this embodiment, memory 304 includes random access memory (RAM). In general, memory 304 can include any suitable volatile or non-volatile computer readable storage media. Cache 306 is a fast memory that enhances the performance of processors 302 by holding recently accessed data, and data near recently accessed data, from memory 304.

Program instructions and data used to practice embodiments of the present invention may be stored in persistent storage 310 and in memory 304 for execution by one or more of the respective processors 302 via cache 306. In an embodiment, persistent storage 310 includes a magnetic hard disk drive. Alternatively, or in addition to a magnetic hard disk drive, persistent storage 310 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 310 may also be removable. For example, a removable hard drive may be used for persistent storage 310. Other examples include optical and magnetic disks, thumb drives, and smart cards that are inserted into a drive for transfer onto another computer-readable storage medium that is also part of persistent storage 310.

Communications unit 314, in these examples, provides for communications with other data processing systems or devices, including resources of network 120. In these examples, communications unit 314 includes one or more network interface cards. Communications unit 314 may provide communications through the use of either or both physical and wireless communications links. Program instructions and data used to practice embodiments of the present invention may be downloaded to persistent storage 310 through communications unit 314.

I/O interface(s) 312 allows for input and output of data with other devices that may be connected to computing device 300. For example, I/O interface 312 may provide a connection to external devices 316 such as a keyboard, keypad, a touch screen, and/or some other suitable input device. External devices 316 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 310 via I/O interface(s) 312. I/O interface(s) 312 also connect to a display 318.

Display 318 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for artifact management, the method comprising:
detecting, by one or more processors, a first artifact in a user interface, wherein the first artifact is in use, and wherein the first artifact is an element within an application requiring user attention;
determining, by one or more processors, one or more related artifacts, wherein the one or more related artifacts are operating in the user interface, and wherein the one or more related artifacts have a degree of relatedness to the first artifact, and wherein the one or more related artifacts are one or more related elements within the application requiring user attention;
generating, by one or more processors, a degree of relatedness for each of the one or more related artifacts;
detecting, by one or more processors, completion of a task associated with the first artifact; and
in response to detecting the task completion, retrieving, by one or more processors, a second artifact, wherein the second artifact is from the one or more related artifacts.

2. The method of claim 1, wherein the degree of relatedness is based, at least in part, on a context of one or more artifact features.

3. The method of claim 1, wherein the degree of relatedness is based, at least in part, on a user pattern, wherein the user pattern is determined by monitoring user interaction with the one or more related artifacts.

4. The method of claim 2, wherein the one or more artifact features comprises: a subject line, a title, a user identification, an author, one or more reader identifications, one or more natural language characteristics, and one or more application identifiers.

5. The method of claim 4, wherein the degree of relatedness is represented by the degree of relatedness, wherein the degree of relatedness is calculated by assigning a weight to each of the one or more artifact features.

6. The method of claim 1, wherein the completion of a task associated with the first artifact is detected by at least one of: (i) deleting the first artifact, (ii) replying to the first artifact, and (iii) closing the first artifact.

7. The method of claim 1, wherein retrieving the second artifact comprises:
comparing, by one or more processors, the degree of relatedness of each of the one or more related artifacts,
determining, by one or more processors, a second artifact with the greatest degree of relatedness; and
displaying, by one or more processors, the second artifact on the user interface.

8. A computer program product for artifact management, the computer program product comprising:
a computer readable storage medium and program instructions stored on the computer readable storage medium, the program instructions comprising:
program instructions to detect a first artifact in a user interface, wherein the first artifact is in use, and wherein the first artifact is an element within an application requiring user attention;
program instructions to determine one or more related artifacts, wherein the one or more related artifacts are operating in the user interface, and wherein the one or more related artifacts have a degree of relatedness to the first artifact, and wherein the one or more related artifacts are one or more related elements within the application requiring user attention;
program instructions to generate a degree of relatedness for each of the one or more related artifacts;
program instructions to detect completion of a task associated with the first artifact; and
program instructions to retrieve a second artifact in response to detecting the task completion, wherein the second artifact is from the one or more related artifacts.

9. The computer program product of claim 8, wherein the degree of relatedness is based, at least in part, on a context of one or more artifact features.

10. The computer program product of claim 8, wherein the degree of relatedness is based, at least in part, on a user pattern, wherein the user pattern is determined by monitoring user interaction with the one or more related artifacts.

11. The computer program product of claim 9, wherein the one or more artifact features comprises: a subject line, a title, a user identification, an author, one or more reader identifications, one or more natural language characteristics, and one or more application identifiers.

12. The computer program product of claim 11, wherein the degree of relatedness is represented by the degree of relatedness, wherein the degree of relatedness is calculated by assigning a weight to each of the one or more artifact features.

13. The computer program product of claim 8, wherein the completion of the task associated with the first artifact is detected by at least one of: (i) deleting the first artifact, (ii) replying to the first artifact, and (iii) closing the first artifact.

14. The computer program product of claim 8, wherein program instructions to retrieve the second artifact further comprises:
program instructions to compare the degree of relatedness of each of the one or more related artifacts,
program instructions to determine a second artifact with the greatest degree of relatedness; and
program instructions to display the second artifact on the user interface.

15. A computer system for artifact management, the computer system comprising:
one or more computer processors;
one or more computer readable storage media;
program instructions stored on the computer readable storage media for execution by at least one of the one or more processors, the program instructions comprising:
program instructions to detect a first artifact in a user interface, wherein the first artifact is in use, and wherein the first artifact is an element within an application requiring user attention;
program instructions to determine one or more related artifacts, wherein the one or more related artifacts are operating in the user interface, and wherein the one or more related artifacts have a degree of relatedness to the first artifact, and wherein the one or more related artifacts are one or more related elements within the application requiring user attention;
program instructions to generate a degree of relatedness for each of the one or more related artifacts;
program instructions to detect completion of a task associated with the first artifact; and
program instructions to retrieve a second artifact in response to detecting the task completion, wherein the second artifact is from the one or more related artifacts.

16. The computer system of claim 15, wherein the degree of relatedness is based, at least in part, on a context of one or more artifact features.

17. The computer system of claim 15, wherein the degree of relatedness is based, at least in part, on a user pattern, wherein the user pattern is determined by monitoring user interaction with the one or more related artifacts.

18. The computer system of claim 16, wherein the one or more artifact features comprises: a subject line, a title, a user identification, an author, one or more reader identifications, one or more natural language characteristics, and one or more application identifiers.

19. The computer system of claim 18, wherein the degree of relatedness is represented by the degree of relatedness, wherein the degree of relatedness is calculated by assigning a weight to each of the one or more artifact features.

20. The computer system of claim 15, wherein the completion of the task associated with the first artifact is detected by at least one of: (i) deleting the first artifact, (ii) replying to the first artifact, and (iii) closing the first artifact, and wherein program instructions to retrieve the second artifact further comprises:
program instructions to compare the degree of relatedness of each of the one or more related artifacts,
program instructions to determine a second artifact with the greatest degree of relatedness; and
program instructions to display the second artifact on the user interface.
